(19) United States
(12) Patent Application Publication
(10) Pub. No.: US 2013/0202280 A1
(43) Pub. Date: Aug. 8, 2013

(54) IMAGING APPARATUS

(71) Applicant: Panasonic Corporation, Osaka (JP)

(72) Inventors: TAKESHI SHIMOHATA, Osaka (JP); MOTONORI OGURA, Osaka (JP)

(73) Assignee: PANASONIC CORPORATION, Osaka (JP)

(21) Appl. No.: 13/756,650

(22) Filed: Feb. 1, 2013

(30) Foreign Application Priority Data
Feb. 2, 2012 (JP) 2012-020573

(51) Int. Cl. G02B 27/64

(52) U.S. Cl. CPC G02B 27/646
USPC 396/55

(57) ABSTRACT

An imaging apparatus includes an optical system, an imaging unit configured to capture an image incident thereon through the optical system, a shake detector configured to detect shake of the apparatus, a shake correction unit including therein a correction lens, and being configured to move the correction lens in a plane perpendicular to the optical axis of the optical system based on a result of the detection by the shake detector to shift an optical axis of the optical system, and a controller configured to control the shake correction unit to cause the correction lens to minutely vibrate, not based on the result of the detection by the shake detector.

### BACKGROUND

1. Technical Field

The present disclosure relates to an imaging apparatus having a camera shake correction function that detects shake of the apparatus and reduces influence of the shake on an image based on the detected shake.

2. Related Art

JP 2004-252486 A describes a drive mechanism for a camera shake correction lens of an imaging apparatus, and a control technique for image blur correction operation during panning and tilting operation.

The imaging apparatus of JP 2004-252486 A controls an operation for correcting image blur based on data on blur correction characteristics stored in a blur correction characteristics storage unit, during panning and tilting operation.

Accordingly, even during panning and tilting operation, excellent blur-free images can be shot.

### SUMMARY

In JP 2004-252486 A described above, an improvement in shooting state is obtained limitedly to panning and tilting operation. However, during actual shooting, jitter of captured image is caused by a friction force in a drive mechanism for a camera shake correction lens and degradation of camera shake correction performance is caused by the friction force.

An object of the present disclosure is to prevent jitter of captured image and degradation of camera shake correction performance which occur by friction in a drive mechanism unit of a lens actuator.

An imaging apparatus according to the present disclosure includes an optical system, an imaging unit configured to capture an image incident thereon through the optical system, a shake detector configured to detect shake of the apparatus, a shake correction unit including therein a correction lens, and being configured to move the correction lens in a plane perpendicular to the optical axis of the optical system based on a result of the detection by the shake detector to shift an optical axis of the optical system, and a controller configured to control the shake correction unit to cause the correction lens to minutely vibrate, not based on the result of the detection by the shake detector.

The imaging apparatus of the present disclosure can reduce image jitter and degradation of camera shake correction performance which are caused by friction in a drive mechanism unit of a lens actuator.

### BRIEF DESCRIPTION OF DRAWINGS

FIG. 1 is a block diagram showing a configuration of a digital video camera;

FIG. 2 is a schematic diagram showing a configuration of an OIS actuator;

FIG. 3 is a block diagram showing a configuration of an OIS driver;

FIG. 4 is a flowchart for an OIS lens (correction lens) (control based on the result of determination of shooting with the camera set on a tripod);

FIG. 5 is a flowchart for control of the OIS lens (control based on the focal length during zoom operation);

FIG. 6 is a diagram of an operation characteristic of a minute signal generator circuit;

FIG. 7 is a flowchart for the OIS lens (control based on the temperature of an apparatus);

FIG. 8 is a diagram of an operation characteristic of the minute signal generator circuit;

FIG. 9 is a flowchart for control of the OIS lens; and

FIG. 10 is a diagram of an operation characteristic of the minute signal generator circuit.

### DETAILED DESCRIPTION OF PREFERRED EMBODIMENTS

Embodiments will be described in detail below with reference to the drawings, as necessary. However, unnecessarily detailed description may be omitted. For example, a detailed description of already well-known matters or an overlapping description of substantially the same configuration may be omitted to avoid the description from unnecessarily becoming redundant and to facilitate understanding by those skilled in the art. Note that the inventor(s) provide(s) the accompanying drawings and the following description in order for those skilled in the art to thoroughly understand the present disclosure, and thus, it is not intended that the subject described in the claims is limited thereby. In the following, description will be made using a digital video camera as an example of an imaging apparatus.

### First Embodiment

### 1. Configuration

1-1. Configuration of Digital Video Camera

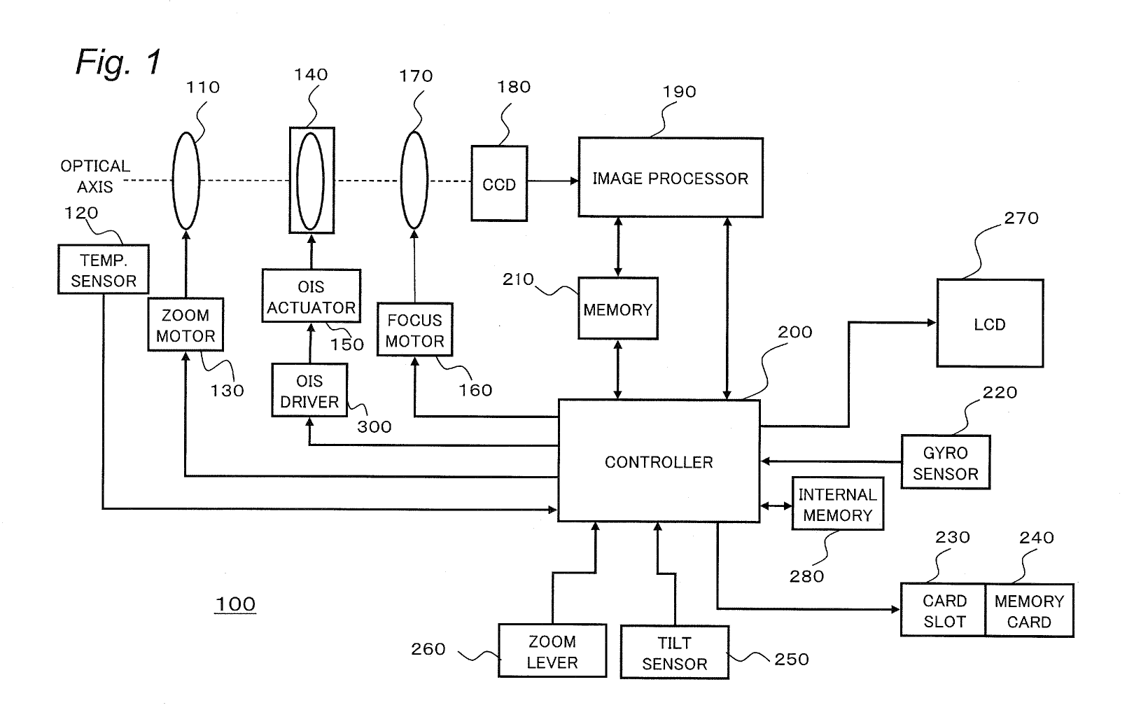

An electrical configuration of a digital video camera according to the present embodiment will be described with reference to FIG. 1. FIG. 1 is a block diagram showing a configuration of a digital video camera. A digital video camera 100 captures a subject image formed by an optical system including a zoom lens 110 and the like with a CCD image sensor 180. Video data generated by the CCD image sensor 180 is subjected to various processes by an image processor 190. The processed video data is stored in a memory card 240. The video data stored in the memory card 240 can be displayed on a liquid crystal display (LCD) monitor 270.

The configuration of the digital video camera 100 will be described in more detail below.

The optical system of the digital video camera 100 includes a zoom lens 110, an OIS lens 140, and a focus lens 170. Note that “OIS” is an abbreviation for Optical Image Stabilizer and refers to optical camera shake correction.

The zoom lens 110 can zoom in or zoom out a subject image by being moved along an optical axis of the optical system. The focus lens 170 moves along the optical axis of the optical system to adjust the focus of the subject image.

The OIS lens 140 includes therein a correction lens which is movable in a plane perpendicular to the optical axis. The OIS lens 140 drives the correction lens in a direction for cancelling shake of the digital video camera 100 to reduce a blur of a subject image in a captured image.

A zoom motor 130 drives the zoom lens 110. The zoom motor 130 may be implemented by a pulse motor, a DC motor, a linear motor, a servomotor, or the like. The zoom motor 130 may drive the zoom lens 110 through a cam mechanism or a mechanism such as a ball screw.

A temperature sensor 120 is a device that detects a temperature of a lens barrel of the digital video camera 100, and a thermistor is normally used for it. The temperature sensor 120 is used for the purpose of correcting optical error occurring due to temperature change.

An OIS actuator 150 drives the OIS lens 140 in the horizontal and vertical directions orthogonal to the optical axis. For the OIS actuator 150, in general, an electromagnetic linear motor configured by a magnet and a coil is used. The OIS actuator 150 is driven by an OIS driver 300. The OIS lens 140, the OIS actuator 150, and the OIS driver 300 compose a shake correction unit.

The CCD image sensor 180 captures a subject image formed by the optical system including the zoom lens 110 and the like, to generate video data. The CCD image sensor 180 performs various operations such as exposure, transfer, and electronic shutter.

The image processor 190 performs various processes on the video data generated by the CCD image sensor 180. The image processor 190 performs processes on the video data generated by the CCD image sensor 180 to generate video data to be displayed on the liquid crystal display monitor 270 or to generate video data to be re-stored in the memory card 240. For example, the image processor 190 performs various processes such as gamma correction, white balance correction, and flaw correction, on the video data generated by the CCD image sensor 180. In addition, the image processor 190 compresses the video data generated by the CCD image sensor 180, using a compression format compliant with the H.264 standard or the MPEG2 standard. The image processor 190 can be implemented by a DSP (Digital Signal Processor), a microcomputer, or the like.

A controller 200 is a control unit that controls the overall operation of the camera. The controller 200 can be implemented by a semiconductor integrated circuit, and may be configured by only hardware or may be implemented by combination of hardware and software.

A memory 210 functions as a working memory for the image processor 190 and the controller 200. The memory 210 can be implemented by, for example, a DRAM or a ferroelectric memory.

The liquid crystal display monitor 270 can display an image represented by video data which is generated by the CCD image sensor 180, and an image represented by video data which is read from the memory card 240.

A gyro sensor 220 is configured by a vibrating element, such as a piezoelectric element, and a signal processing circuit. The gyro sensor 220 causes the vibrating element to vibrate at a fixed frequency and converts a force by the Coriolis force into a voltage to obtain angular velocity information. The digital video camera 100 obtains the angular velocity information from the gyro sensor 220 and drives the correction lens in the OIS lens 140 in a direction to cancel this jitter to correct camera shake caused by the user.

A card slot 230 allows the memory card 240 to be inserted therein. The card slot 230 can be mechanically and electrically connected to the memory card 240. The memory card 240 includes therein a flash memory, a ferroelectric memory, or the like, and can store data.

An internal memory 280 is configured by a flash memory, a ferroelectric memory, or the like. The internal memory 280 stores a control program for performing overall control of the digital video camera 100, and the like.

A tilt sensor 250 detects tilt of the digital video camera 100 during shooting. A zoom lever 260 is a member that receives an instruction to change the zoom magnification from a user.

1-2. Configuration of OIS Actuator

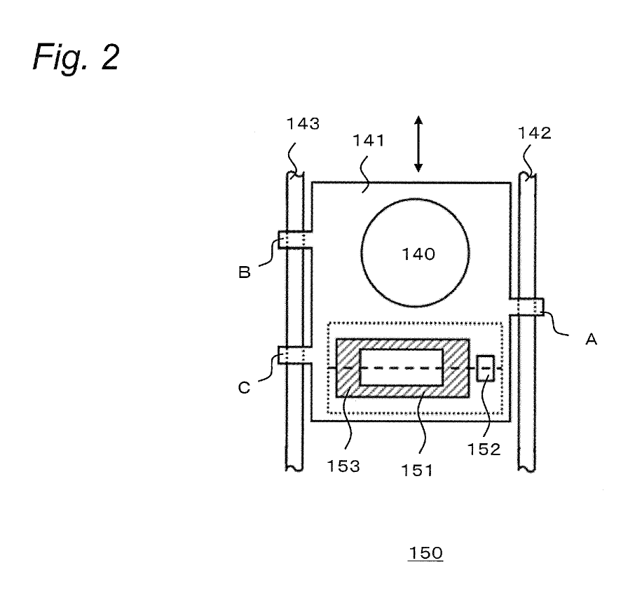

Next, a configuration of the OIS actuator 150 will be described with reference to FIG. 2. FIG. 2 is a diagram showing an example of the configuration of the OIS actuator 150 provided in the lens barrel of the digital video camera 100. In FIG. 2, the OIS lens 140 moves in a direction orthogonal to the optical axis to correct deviation of the optical axis caused by camera shake. The OIS lens 140 is fixed in a moving frame 141 and moves by movement of the moving frame 141. The moving frame 141 is normally formed by molding a resin material. A drive coil 151 is fixed to the moving frame 141. A drive magnet 153 is disposed at a lower portion of the moving frame 141. In addition, a Hall element 152 that detects a magnetic field of the drive magnet 153 is fixed to the moving frame 141. Projecting portions A, B, and C of the moving frame 141 are provided with openings. Shafts which are made of metal or resin are inserted into the openings. Specifically, a shaft 142 is inserted into the opening of the projecting portion A. A shaft 143 is inserted into the openings of the projecting portions B and C. Grease is applied to the surfaces of the shafts 142 and 143 for the purpose of reducing friction. FIG. 2 shows only a mechanism for driving the OIS lens 140 in an up-and-down direction. The OIS actuator 150 is configured by the mechanism shown in FIG. 2 and a mechanism having the similar configuration to the mechanism shown in FIG. 2 to drive the OIS lens 140 in a left-and-right direction. That is, the OIS actuator 150 can be implemented by combination in two stage of two mechanisms having the same configuration as the mechanism shown in FIG. 2. Note that the mechanism shown in FIG. 2 is just an example, and any other mechanism that drives the OIS lens 140 in direction orthogonal to the optical axis can also be used.

1-3. Configuration of OIS Driver

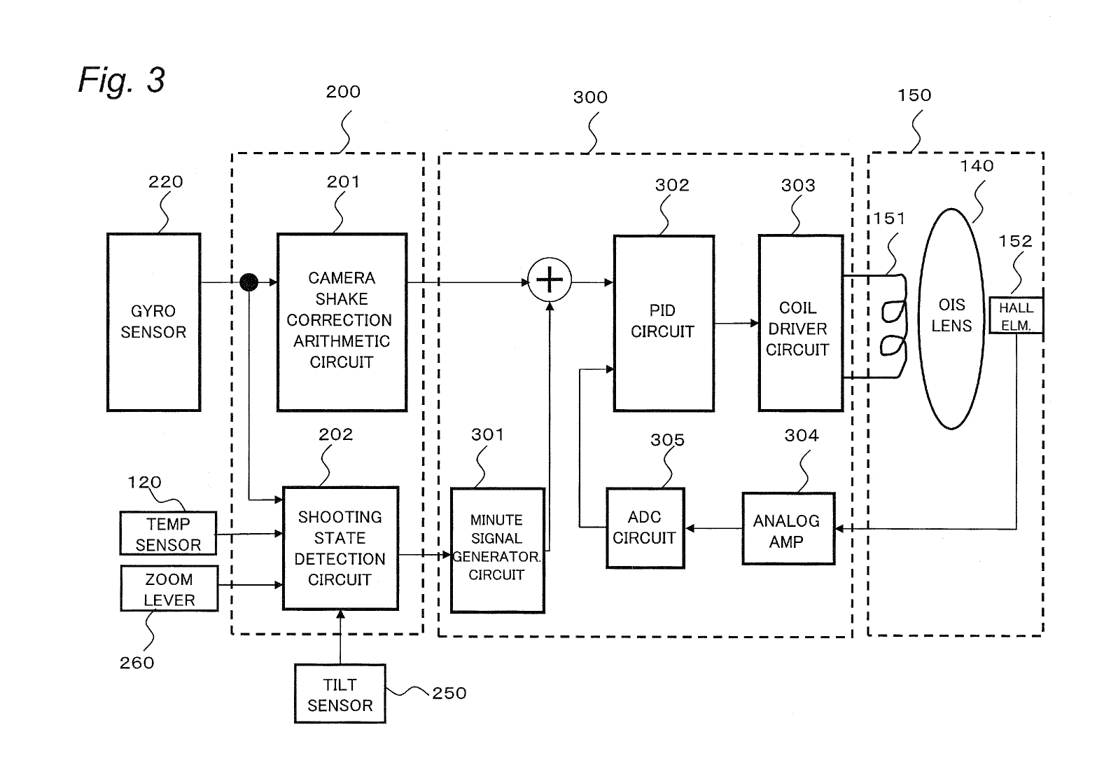

Next, a detailed configuration of the OIS driver 300 will be described with reference to FIG. 3. To describe the flow of control signals, FIG. 3 shows a circuit configuration of a part of the controller 200 and connection with the OIS actuator 150 in addition to the configuration of the OIS driver 300.

The controller 200 has a plurality of functional blocks. For convenience of description, FIG. 3 shows a camera shake correction arithmetic circuit 201 that calculates the amount of correction of the OIS lens 140 from an angular velocity signal outputted from the gyro sensor 220; and a shooting state detection circuit 202 that detects a shooting state from an output from the temperature sensor 120 that detects a temperature of the lens barrel, an operating state of the zoom lever 260, an output signal from the tilt sensor 250, and the like.

The OIS driver 300 includes a minute signal generator circuit 301, a proportional-integral-derivative (PID) circuit 302, a coil driver circuit 303, an analog amplifier circuit 304, an AD converter circuit 305, and various circuit elements.

The minute signal generator circuit 301 is a digital signal generator circuit that generates a continuous digital signal, such as a sine wave, a triangular wave, or a trapezoidal wave with a relatively high frequency and a relatively small amplitude. The minute signal generator circuit 301 is configured to change the type, frequency, and amplitude of a generated signal according to an output from the shooting state detection circuit 202, i.e., a shooting state of the camera.

The analog amplifier circuit 304 performs analog amplification to an output signal from the Hall element 152 which moves integrally with the OIS lens 140. A signal from the analog amplifier circuit 304 represents the position of the OIS lens 140.

The AD converter circuit 305 converts the analog output signal from the analog amplifier circuit 304 into a digital signal. An output from the AD converter circuit 305 is inputted to the proportional-integral-derivative circuit 302.

The proportional-integral-derivative circuit 302 is a digital filter circuit that performs a proportional process, an integral process, and a derivative process on a difference between an output signal from the camera shake correction arithmetic circuit 201 which is inputted as a digital signal and the digital signal output from the AD converter circuit 305. The frequency characteristics and the amplification factor for the proportional, integral, and derivative processes are determined from the mass of the OIS lens 140 and the thrust characteristics of the OIS actuator 150, and are set to values having adequate oscillation margin in terms of control characteristics.

The coil driver circuit 303 amplifies an output signal from the proportional-integral-derivative circuit 302 and supplies a drive current to the drive coil 151 (PID control). The coil driver circuit 303 outputs an analog signal or outputs a PWM signal. The operation of the OIS lens 140 is same for both cases, and the present embodiment is not limited to either one.

### 2. Operation

The operation of the digital video camera 100 having the above-described configuration will be described below.

2-1. Problem of Friction in OIS Actuator

First, the problem of friction in the OIS actuator 150 will be described. The present embodiment aims at achieving high-quality, blur-free shot images by detecting the amount of shake of the digital video camera 100 with the gyro sensor 220 and controlling the OIS actuator 150 with the controller 200 and the OIS driver 300 to allow the OIS lens 140 to correct the optical axis.

However, in the configuration of the OIS actuator 150 described in FIG. 2, the OIS lens 140 is driven using the shafts made of metal or resin, and resin members provided with openings. Hence, when the shaft slides within the opening, mechanical friction always occurs. To reduce the friction, grease is normally applied to the surfaces of the shafts. However, even if grease is applied, it is impossible to completely eliminate a friction force. Due to the influence of the friction force, two problematic phenomena may occur.

The first problem is that a shooting screen jitters when the digital video camera 100 is placed upward or downward using a tripod. This is due to occurrence of a phenomenon called “stick-slip” in which a repetition of moving and stopping of the OIS lens 140 continues at a relatively low cycle.

The stick-slip is caused by an increase in static friction force due to weights of the OIS lens 140 and the OIS actuator 150 applied on the shaft portions. When the static friction force increases, the thrust generated by the OIS actuator 150 also increases to maintain the state at rest. Thus, at the moment when the thrust exceeds the static friction force, the OIS lens 140 starts to move as if sliding, and at the next moment the OIS lens 140 is subjected to dynamic control and is thereby placed in the state at rest, and these movement and stop are repeated. When this stick-slip phenomenon occurs, despite the fixation of the digital video camera 100 on the tripod, the OIS lens 140 periodically moves, causing a problem of jitter of a shooting screen.

The second problem is that camera shake correction cannot be sufficiently performed for camera shake during shooting with the camera held by user's hands. Although the OIS lens 140 is controlled to cancel out camera shake by the configuration shown in FIG. 1, if the friction force is large, the OIS lens 140 is not driven as instructed so that a blur remains in a shot image. The remaining blur in the shot image caused by the camera shake becomes more apparent as the focal length of the lens increases, i.e., the zoom magnification increases. In recent years, the zoom magnification of a digital video camera and a digital still camera has increased more and more. Thus, it is an important purpose to reduce a remaining blur in a shot image caused by a friction force.

Furthermore, the viscous drag of the grease applied to the shafts often changes by temperature. In general, at low temperatures, the viscosity increases and thus the friction force increases. At high temperatures, the viscosity decreases and thus the friction force decreases. Hence, because the friction force changes by temperature, another problem arises that a remaining blur in a shot image caused by camera shake changes by temperature.

As such, the friction force in the OIS actuator 150 greatly affects the quality of a shot image and the performance of camera shake correction.

Hence, in the digital video camera 100 of the present embodiment, in order to solve the problems caused by the friction force, the OIS driver 300 includes the minute signal generator circuit 301. The minute signal generator circuit 301 is, as described above, a digital signal generator circuit that generates a continuous digital signal, such as a sine wave, a triangular wave, and a trapezoidal wave, having a relatively high frequency and a relatively small amplitude.

In the OIS driver 300, a signal from the minute signal generator circuit 301 is superimposed on an output from the camera shake correction arithmetic circuit 201 which is a control signal for the OIS lens 140, and the resulting signal is inputted to the proportional-integral-derivative circuit 302. The coil driver circuit 303 energizes the drive coil 151 so as to follow a camera shake correction signal and the minute signal. Here, the minute vibration of the OIS lens 140 is set to the extent that subject vibration in a shot image cannot be sensed by the user. Such minute vibration has the effect of reducing a static friction force generated between the shafts 142 and 143 and the moving frame 141, and thus a stick-slip phenomenon occurring due to friction can be suppressed. Likewise, by the reduction in friction force, even if there is minute camera shake, the OIS lens 140 can move in substantially the same manner as a manner based on an output from the camera shake correction arithmetic circuit 201, and thus, shot images with very little blur can be obtained.

The control as to whether to perform the minute vibration operation may be switched according to various shooting conditions.

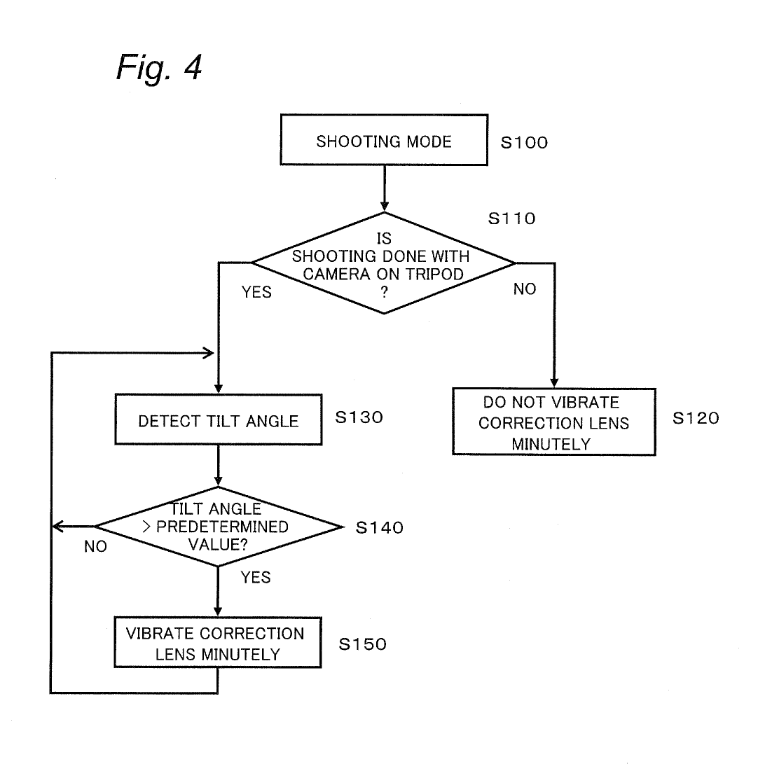

With reference to FIGS. 4 to 10, the control operation of the OIS lens 140 in the digital video camera 100 for various shooting conditions will be described below.

2-2. Control of OIS Lens in Consideration of Tripod Shooting

FIG. 4 is a flowchart showing an example of a control method for the OIS lens 140 which determines, as a shooting condition, whether image-shooting is performed with the digital video camera 100 fixed on a tripod (referred to as “tripod shooting”).

When the digital video camera 100 is in shooting mode (S100), the shooting state detection circuit 202 determines whether it is in the tripod shooting (S110). A result of the determination is outputted to the minute signal generator circuit 301. Determination of tripod shooting can be performed, for example, based on an output from the gyro sensor 220. Specifically, it is determined to be in tripod shooting, when a state in which the amplitude of an output from the gyro sensor 220 is less than or equal to a predetermined value continues for a predetermined period (i.e., when a state in which the shake of the imaging apparatus is very small continues for a predetermined period of time). Alternatively, for another method for determination of the tripod shooting, it may be made based on an output from a contact sensor (a switch or the like) which is provided in a tripod hole and the like.

When the digital video camera 100 is determined to not be in tripod shooting (NO in S110), the shooting state detection circuit 202 controls the minute signal generator circuit 301 not to operate (S120). In this case, shooting is performed without causing the OIS lens (correction lens) 140 to minutely vibrate.

When it is determined to be in tripod shooting (YES in S110), tilt of the digital video camera 100 is detected with the tilt sensor 250 or the like (S130), and it is detected whether the detected tilt is greater than or equal to a predetermined value (e.g., 45 degrees upward) (S140). When the detected tilt is greater than or equal to the predetermined value (e.g., 45 degrees upward), the shooting state detection circuit 202 controls the minute signal generator circuit 301 to output a signal with a predetermined frequency and a predetermined amplitude, thereby causing the OIS lens (correction lens) 140 to minutely vibrate (S150). Accordingly, a friction force generated at the shafts 142 and 143 is reduced, enabling to avoid oscillation of the OIS lens 140 caused by a stick-slip phenomenon.

2-3. Control in Consideration of Focal Length During Zoom Shooting

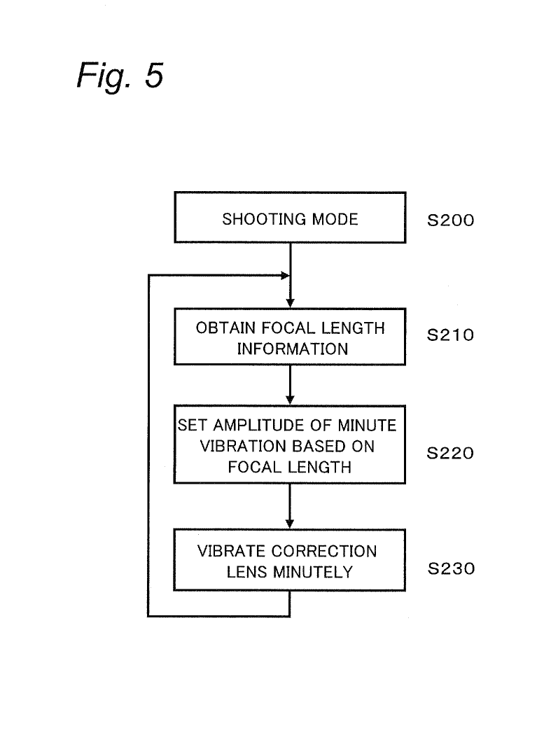

FIG. 5 is a flowchart showing a control method for the OIS lens 140 performed when a zoom operation is performed.

As described above, in the case of zoom shooting, the amount of blur in a shot image caused by camera shake is proportional to the focal length. For example, when a zoom lens capable of achieving a maximum magnification of 10× is used, for the same amount of camera shake, the amount of blur on a screen at the telephoto end is 10 times as much as the amount of blur at the wide end. Therefore, the remaining blur caused by a friction force increases as the zoom magnification increases.

To solve this, in the present embodiment, the amplitude of an output signal from the minute signal generator circuit 301 is increased in proportion to the focal length.

Specifically, the shooting state detection circuit 202 sequentially obtains focal length information from the operating state of the zoom lever 260 (S210). The shooting state detection circuit 202 sets the amplitude of an output signal from the minute signal generator circuit 301, according to a focal length indicated by the obtained focal length information (S220). Then, the shooting state detection circuit 202 outputs a signal indicating the set amplitude to the minute signal generator circuit 301. The minute signal generator circuit 301 outputs a control signal for providing minute vibration according to the set amplitude. Accordingly, the OIS lens (correction lens) 140 is caused to minutely vibrate (S230).

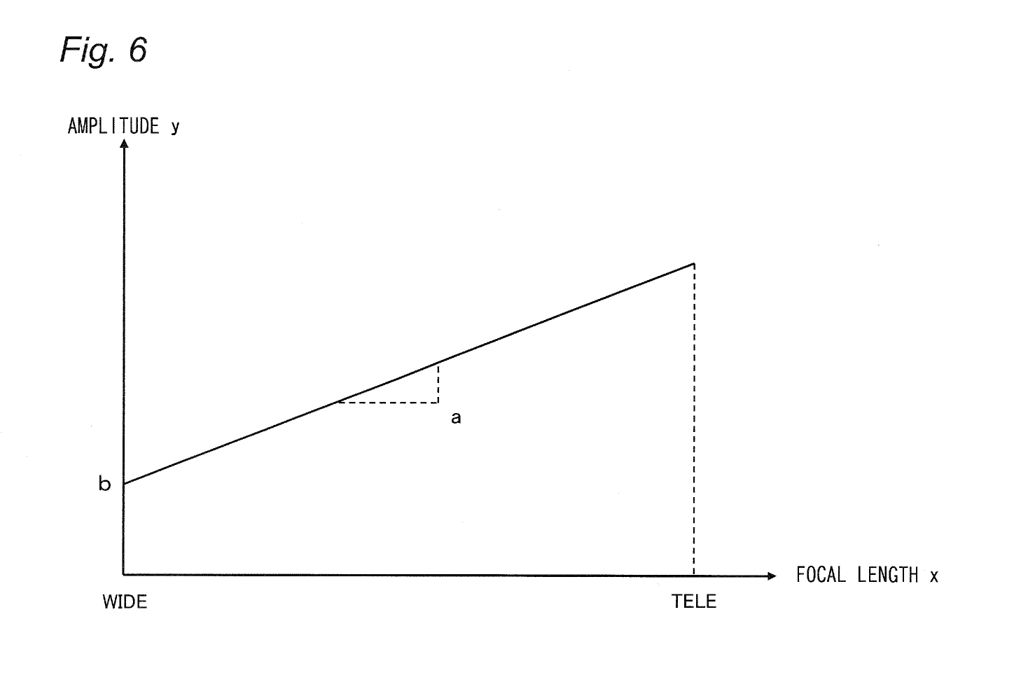

FIG. 6 is a diagram showing an example of the setting of the amount of amplitude of an output signal from the minute signal generator circuit 301 with respect to the focal length. As shown in the drawing, the amount of amplitude of an output signal from the minute signal generator circuit 301 is increased in proportion to the focal length.

For example, the amount of amplitude is controlled such that y=a·x+b is satisfied, where y is the amount of amplitude of an output signal from the minute signal generator circuit 301, x is the focal length, and b is the amount of amplitude at the wide end.

As the amplitude of minute vibration of the OIS lens 140 increases, the friction force generated between the shafts 142 and 143 and the moving frame 141 can be reduced more. In addition, as described above, the amount of movement of the OIS lens 140 to be moved for camera shake correction increases as the focal length during zoom shooting increases. In view of these, the present embodiment increases the amplitude of minute vibration in proportion to the focal length, such that smooth actuation of the OIS lens 140 is achieved upon camera shake correction during zoom operation.

2-4. Control in Consideration of Temperature Change

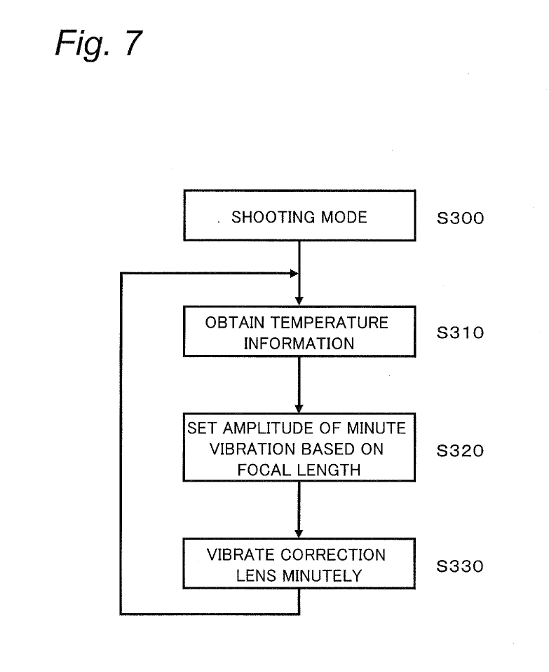

FIG. 7 is a flowchart showing a control method of the OIS lens 140 taking into account a change in the temperature of the lens barrel.

As described above, due to the temperature characteristics of the viscosity of the grease applied to the surfaces of the shafts, the friction force increases as the temperature decreases and thus a remaining blur in a shot image increases. To solve this, setting is performed such that the amplitude of an output signal from the minute signal generator circuit 301 increases as the temperature of the lens decreases.

Specifically, the shooting state detection circuit 202 sequentially detects a temperature of the OIS lens 140 from the temperature sensor 120 (S310). The shooting state detection circuit 202 sets the amplitude of an output signal from the minute signal generator circuit 301 according to the detected temperature, and outputs the set amplitude to the minute signal generator circuit 301 (S320). The minute signal generator circuit 301 outputs a control signal for providing minute vibration according to the amplitude set by the shooting state detection circuit 202, thus to cause the OIS lens (correction lens) 140 to minutely vibrate (S330).

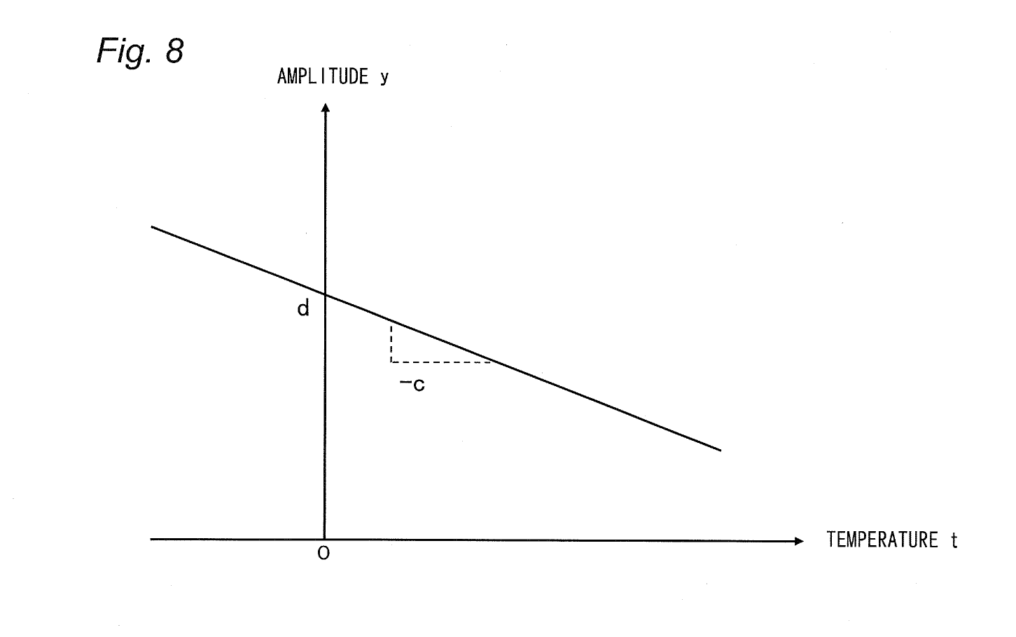

FIG. 8 is a diagram showing an example of the setting of the amount of amplitude of an output signal from the minute signal generator circuit 301 with respect to the temperature of the OIS lens 140. As shown in the figure, the amplitude is increased as the temperature of the OIS lens 140 decreases.

For example, the amount of amplitude of the output signal from the minute signal generator circuit 301 is controlled such that y=−c·t+d is satisfied, where y is the amount of amplitude of an output signal from the minute signal generator circuit 301, t is the temperature of the lens, and d is the amount of amplitude at zero degrees.

By thus setting the amount of amplitude of an output signal from the minute signal generator circuit 301 according to the temperature of the lens, even under low temperature environment, the influence of friction can be more reliably eliminated. In the above-described example, although a temperature of the lens barrel is detected, a part of which temperature is detected is not limited thereto. A temperature of any part of the digital video camera 100 may be detected as long as the part reflects a change in the temperature of the grease applied to the surfaces of the shafts.

2-5. Control in Consideration of Various Shooting Conditions

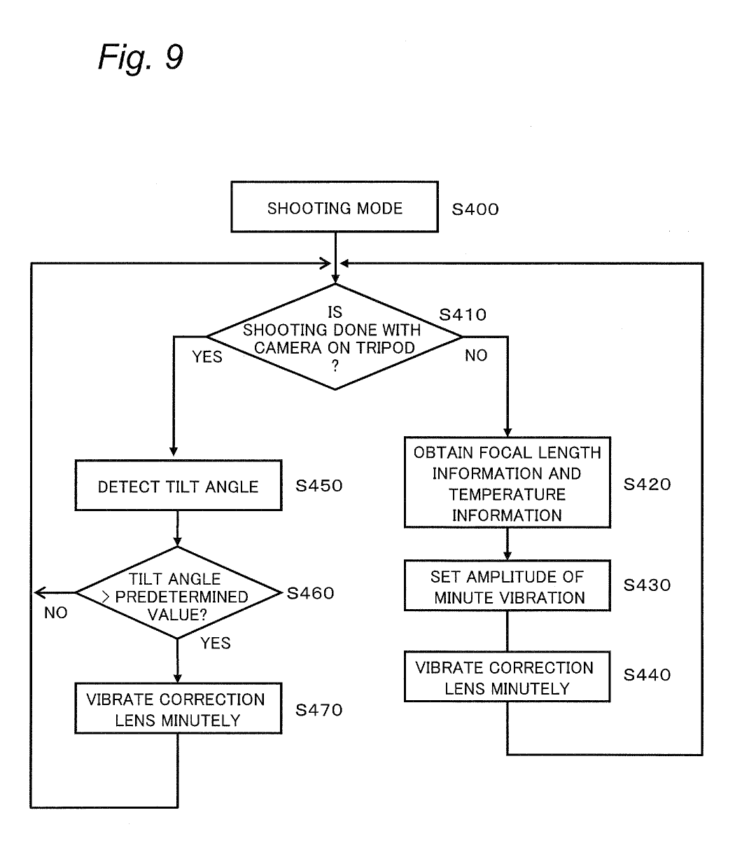

FIG. 9 is a flowchart showing a control method of the OIS lens 140 taking into account tripod shooting, a change in focal length, and a change in the temperature of the lens.

The shooting state detection circuit 202 determines whether the shooting is in tripod shooting (S410). A process (S450 to S470) performed when it is determined to be in tripod shooting (YES in S410) is the same as the process (S130 to S150) described in the flowchart of FIG. 4.

When it is determined to be not in tripod shooting, i.e., when it is determined to be normal shooting (NO in S410), the shooting state detection circuit 202 simultaneously obtains focal length information and temperature information (S420). Then, based on the information obtained by the shooting state detection circuit 202, the minute signal generator circuit 301 sets the amplitude of an output signal according to the focal length and the temperature of the lens, and outputs the set amplitude (S430, S440).

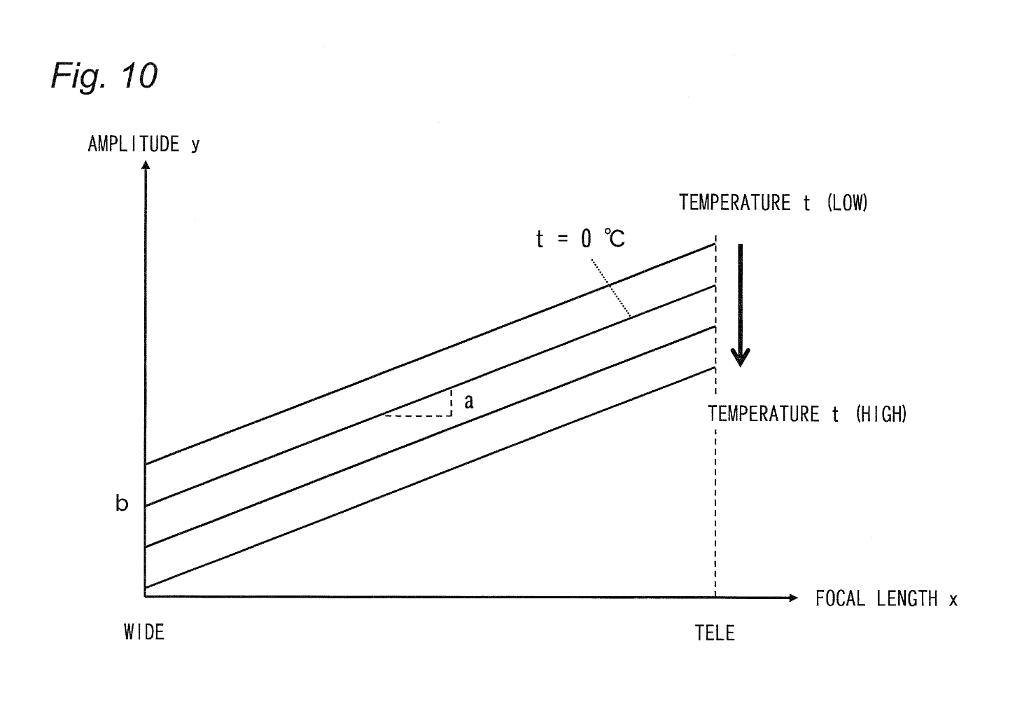

FIG. 10 is a diagram showing an example of the setting of the amount of amplitude of an output signal from the minute signal generator circuit 301 with respect to the focal length and the temperature change.

The amount of amplitude is controlled such that y=a·x+(b−c·t) is satisfied, where y is the amount of amplitude of an output signal from the minute signal generator circuit 301, x is the focal length, b is the amount of amplitude at a lens temperature of zero degrees and at the wide end, t is the temperature of the lens, and c is the coefficient of the temperature.

### 3. Effects, and the Like

As described above, in the present embodiment, the digital video camera 100 includes the optical system 110, 170, . . . , the CCD 180 that captures an image incident thereon through the optical system, the gyro sensor 220 that detects shake of the digital video camera 100, the shake correction unit 140, 150, and 300 that includes therein a correction lens and that moves the correction lens in a plane perpendicular to the optical axis of the optical system based on a result of the detection by the gyro sensor 220 to shift an optical axis of the optical system, and the controller 200 that controls the shake correction unit 140, 150, and 300 to cause the correction lens to minutely vibrate, not based on the result of the detection by the gyro sensor 220.

By the above-described configuration, minute vibration is provided to the shafts 142 and 143 of the OIS actuator 150, and thus the friction between the shafts 142 and 143 and the moving frame 141 is reduced. Accordingly, a stick-slip phenomenon can be prevented, and the moving frame 141 can be smoothly actuated at the start of camera shake correction operation.

### Other Embodiments

As described above, the first embodiment is described as exemplification of a technique disclosed in the present application. However, the technique in the present disclosure is not limited thereto, and can also be applied to embodiments where changes, replacement, addition, omission, and the like are appropriately made. In addition, a new embodiment can also be made by combining the components described in the above-described embodiment. Other embodiments will be exemplified below.

In the above-described embodiment, control of the amount of amplitude of an output signal from the minute signal generator circuit 301 is proportional to the focal length and the temperature of the lens, but it may be allowed to change in a quadratic function manner. In addition, not only the amplitude of the output signal from the minute signal generator circuit 301, but also frequency may be allowed to change. Various applications are possible depending on the configuration of the OIS actuator 150 and the condition of generation of a friction force.

During moving image shooting, the drive sound of the lens becomes problematic as noise. Hence, the shooting state detection circuit 202 may determine whether the shooting mode of the digital video camera 100 is a moving image shooting mode or a still image shooting mode. Then, based on a result of the determination, the minute signal generator circuit 301 may not output a signal for minute vibration when the digital video camera 100 is in the moving image shooting mode, and may output a signal for minute vibration when the digital video camera 100 is in the still image shooting mode. Accordingly, while influence of friction caused by camera shake is eliminated during still image shooting, degradation in video quality caused by noise resulting from minute vibration during moving image shooting can be prevented.

The optical system and drive system of the digital video camera 100 according to the present embodiment are not limited to those shown in FIG. 1. For example, although FIG. 1 exemplifies an optical system of a three-group configuration, a lens configuration of other group configurations may be employed. In addition, each lens may be formed of a single lens or may be configured by a lens group including a plurality of lenses.

Furthermore, in the present embodiment, although the CCD image sensor 180 is exemplified as an imaging unit, the present disclosure is not limited thereto. The imaging unit may be configured by, for example, a CMOS image sensor or an NMOS image sensor.

Although the present embodiment shows the configuration in which minute vibration is applied to the OIS lens 140, minute vibration may also be applied to other lenses (e.g., a focus lens and a zoom lens). This can also reduce the influence of a friction force in the actuator on the focus lens and the zoom lens.

As described above, the embodiment is described as exemplification of the technique in the present disclosure. For this purpose, the accompanying drawings and the detailed description are provided.

Therefore, the components described in the accompanying drawings and the detailed description may include not only components necessary to solve the problems, but also components not necessary to solve the problems in order to exemplify the above-described technique. Hence, it should not be assumed that the unnecessary components described in the accompanying drawings and the detailed description limit the various embodiments.

In addition, since the above-described embodiment is to exemplify the technique in the present disclosure, various changes, replacement, addition, omission, and the like may be made thereto within the range of the claims or within the range of equivalency of the claims.

### INDUSTRIAL APPLICABILITY

The present disclosure can be applied to imaging apparatuses such as digital video cameras and digital still cameras.

What is claimed is:

1. An imaging apparatus comprising:
an optical system;
an imaging unit configured to capture an image incident thereon through the optical system;
a shake detector configured to detect shake of the apparatus;
a shake correction unit including therein a correction lens, and being configured to move the correction lens in a plane perpendicular to the optical axis of the optical system based on a result of the detection by the shake detector to shift an optical axis of the optical system; and
a controller configured to control the shake correction unit to cause the correction lens to minutely vibrate, not based on the result of the detection by the shake detector.

2. The imaging apparatus according to claim 1, wherein
the optical system includes a zoom lens, and
the controller controls the shake correction unit to change an amplitude of the minute vibration according to a focal length of the optical system.

3. The imaging apparatus according to claim 2, wherein the controller increases the amplitude of the minute vibration as the focal length of the optical system increases.

4. The imaging apparatus according to claim 1, further comprising a temperature sensor configured to detect a temperature of the optical system, wherein
the controller controls the shake correction unit to change the amplitude of the minute vibration according to the temperature detected by the temperature sensor.

5. The imaging apparatus according to claim 4, wherein the controller increases the amplitude of the minute vibration as the temperature detected by the temperature sensor decreases.

6. The imaging apparatus according to claim 1, wherein the controller controls the shake correction unit to cause the correction lens to minutely vibrate, when a state where a magnitude of the shake detected by the shake detector is smaller than a predetermined value continues for a predetermined period of time or more.

7. The imaging apparatus according to claim 1, further comprising a tilt sensor configured to detect tilt in a forward-and-backward direction of the apparatus, wherein
the controller determines whether to cause the correction lens to minutely vibrate, according to a magnitude of the tilt detected by the tilt sensor.

8. An imaging apparatus comprising:
an optical system;
an imaging unit configured to capture an image incident thereon through the optical system;
a shake detector configured to detect shake of the apparatus;
a shake correction unit including therein a correction lens, and being configured to move the correction lens in a plane perpendicular to the optical axis of the optical system based on: a result of the detection by the shake detector to shift an optical axis of the optical system; and
a controller configured to control the shake correction unit to cause the correction lens to minutely vibrate at an amplitude according to a focal length of the optical system, a temperature of the optical system and a tilt in a forward-and-backward direction of the apparatus.
